(19) United States
(12) Patent Application Publication
(10) Pub. No.: US 2024/0085453 A1
(43) Pub. Date: Mar. 14, 2024

(54) METHOD FOR EVALUATING SENSOR DATA, PROCESSING UNIT FOR EVALUATING SENSOR DATA, AND SENSOR SYSTEM

(71) Applicant: Robert Bosch GmbH, Stuttgart (DE)

(72) Inventors: Timo Heikkilae, Kusterdingen (DE); Rui Zhang, Wannweil (DE)

(21) Appl. No.: 18/447,151

(22) Filed: Aug. 9, 2023

(30) Foreign Application Priority Data
Sep. 9, 2022 (DE) 10 2022 209 393.3

(51) Int. Cl. G01P 21/00; G01P 3/44; G01P 15/08

(52) U.S. Cl. CPC G01P 21/00; G01P 3/44; G01P 15/0802

(57) ABSTRACT

A method for evaluating sensor data. Raw sensor data and/or processed sensor data are initially read in from an acceleration sensor and a rotation rate sensor. Measured data are subsequently ascertained from the raw sensor data and/or the processed sensor data. In addition, at least one application criterion is ascertained. The measured data are then corrected based on a mathematical model. In the correction, an angle between a direction of a sensor orientation and a motion direction is maximally changed by a predefined value per time unit when the application criterion is met. The corrected measured data are subsequently output.

### CROSS REFERENCE

The present application claims the benefit under 35 U.S.C. § 119 of German Patent Application No. DE 10 2022 209 393.3 filed on Sep. 9, 2022, which is expressly incorporated herein by reference in its entirety.

### FIELD

The present invention relates to a method for evaluating sensor data, a processing unit configured to carry out the method, and a sensor system.

### BACKGROUND INFORMATION

Methods are described in the related art in which raw sensor data or processed sensor data are converted into measured data. The measured data may be subsequently corrected with the aid of a mathematical model in which measured data generated from the raw sensor data are processed. The mathematical model may in particular include a filter, for example a Kalman filter. In particular, such a method may be used for evaluating acceleration sensor data and rotation rate sensor data.

### SUMMARY

An object of the present invention is to provide an improved method for evaluating sensor data, a processing unit for carrying out the method, and an improved sensor system. These objects may be achieved via features of the present invention. Advantageous embodiments and refinements of the present invention are disclosed herein.

According to an example embodiment of the present invention, a method for evaluating sensor data includes the steps explained below. Raw sensor data and/or processed sensor data from an acceleration sensor and a rotation rate sensor are initially read in. Measured data are subsequently ascertained from the raw sensor data and/or the processed sensor data. In addition, at least one application criterion is ascertained. The measured data are then corrected based on a mathematical model, in the correction an angle between a direction of a sensor orientation and a motion direction being maximally changed by a predefined value per time unit when the application criterion is met. The corrected measured data are subsequently output. The sensor orientation may be referred to in particular as a yaw angle or as an alignment.

According to an example embodiment of the present invention, the measured data may in particular involve the motion direction and the direction of the sensor orientation. The motion direction may correspond to a direction of a velocity vector. With the aid of the application criterion, it may be decided whether a certain relation between the motion direction and the direction of the sensor orientation may be held essentially constant. The underlying concept is that there may be motion situations in which the direction of the sensor orientation, i.e., the position of a sensor in space, is not changed relative to the motion direction when the sensor moves. This may be the case in particular when the sensor is carried, for example in a mobile phone or in some other handheld device. In addition, this may also apply when the sensor is situated in a vehicle. This may be utilized in particular for coupled navigation and/or inertial navigation. Due to the necessary integration of the measured data for these types of navigation, even small deviations may result in large errors. These errors may be reduced by predefining the relation between the motion direction and the direction of the sensor orientation. In addition, it may be provided that no further sensors are used besides the acceleration sensor and the rotation rate sensor.

According to an example embodiment of the present invention, the raw sensor data and/or the processed sensor data may either be output as an analog signal, for example in the form of a voltage, or may have already been converted into a digital signal in the sensors with the aid of electronics and A/D converters. The processed sensor data may be designed in such a way that a first variable is ascertained with the aid of the sensor, and a second variable is computed from the first variable. For example, raw sensor data of the acceleration sensor (acceleration data) may be processed to form speed data by integrating the acceleration data and thus ascertaining speeds. The processing of the raw sensor data may take place within the sensor. In addition, the processing of the raw sensor data may also take place in a processing unit that carries out the method. In particular for processed sensor data, small measuring errors or deviations in the raw sensor data due to the processing, in particular due to the integration, may result in large deviations in the processed sensor data. The method according to the present invention allows these deviations to be greatly reduced, since the speed data, which rapidly deviate due to the integration, may be checked, at least with regard to a motion direction, and corrected if necessary. This results from the implementation with the aid of the mathematical model.

The method according to the present invention may be implemented in such a way that in the mathematical model in the standard state, the angle between the direction of the sensor orientation and the motion direction is maximally changed by the predefined value per time unit, and the angle between the direction of the sensor orientation and the motion direction may also be changed by a larger amount than the predefined value only when the application criterion suggests that this relation is not to be used. However, it may also alternatively be provided that the presence of the application criterion is checked, and the mathematical model is appropriately changed only if the application criterion is present, so that the angle between the direction of the sensor orientation and the motion direction may be maximally changed by the predefined amount.

The present invention also encompasses a processing unit that includes an input, an output, and a processor. The processing unit is configured to receive raw sensor data and/or processed sensor data via the input, subsequently carry out the method according to the present invention with the aid of the processor, and thereafter output the corrected measured data via the output. The processing unit may be configured to generate processed sensor data from the raw sensor data. For example, raw sensor data of an acceleration sensor (acceleration data) may be processed by the processing unit to form speed data by integrating the acceleration data and thus ascertaining speeds.

The present invention further encompasses a sensor system that includes a processing unit according to the present invention, an acceleration sensor, and a rotation rate sensor. The acceleration sensor and the rotation rate sensor are configured to convert a physical measured variable into raw sensor data and/or processed sensor data and output them to the input of the processing unit. In particular, it may be provided that the sensors, i.e., the acceleration sensor and the rotation rate sensor, together with the processing unit are accommodated within a component, for example within an ASIC. The sensors may be configured to generate processed sensor data from the raw sensor data. For example, raw sensor data of the acceleration sensor (acceleration data) may be processed to form speed data by integrating the acceleration data and thus ascertaining speeds.

In one specific embodiment of the method of the present invention, the predefined value per time unit is ten degrees per hour. Below this value, it may be assumed that a change in the relation between the motion direction and the direction of the sensor orientation is due to, for example, fatigue during a motion, for example during walking, and does not take place because of a general change in the sensor positioning. However, this also allows slow, gradual changes in position to be included. In addition, it may be alternatively provided that the predefined value per time unit is five degrees per hour.

In one specific embodiment of the method of the present invention, the angle between the direction of the sensor orientation and the motion direction is held constant. This allows a simple mathematical implementation of the mathematical model. The angle between the direction of the sensor orientation and the motion direction may be held absolutely constant. In addition, it is possible that average values are formed for the motion direction and/or the sensor orientation, and the angle between the average sensor orientation and the motion direction or the angle between the sensor orientation and the average motion direction or the angle between the average sensor orientation and the average motion direction is held constant. This may be helpful in particular when the sensor is held in the hand, for example, and arm vibrations, for example, are to remain disregarded. The averages may be computed using a low pass filter, or as a moving average.

In one specific embodiment of the method of the present invention, the mathematical model includes a probabilistic filter. The probabilistic filter may be designed as an H-infinity filter, as a sequential Monte Carlo (SMC) filter, or as a Kalman filter. The Kalman filter may be designed, for example, as a nonlinear Kalman filter, i.e., among other things, as an extended Kalman filter or as cubature Kalman filter, in particular as a square root cubature Kalman filter.

In particular when the mathematical model includes a Kalman filter, the angle between the direction of the sensor orientation and the motion direction may form a state of the Kalman filter. Depending on whether or not the application criterion is present, this state may be occupied with a great or a small uncertainty.

In one specific embodiment of the method of the present invention, the at least one application criterion involves a recognized motion at a minimum speed. If the sensor does not move or moves at a very small speed below the minimum speed, a motion direction cannot be reliably determined. This may be possible beginning above approximately 0.25 meter per second, so that this value may correspond to the minimum speed. Alternatively, 0.5 meter per second may also be provided as a minimum speed.

In one specific embodiment of the method of the present invention, the at least one application criterion involves maintenance of a sensor position. As a result, motions of the sensor relative to a user may be disregarded. For example, during walking the sensor could be initially held in the hand and subsequently held against the ear, resulting in a change in the sensor position. While the sensor position is changing, the relation between the direction of the sensor orientation and the motion direction is not to be held essentially constant, since this relation is not constant due to the change in the sensor position.

In one specific embodiment of the method of the present invention, the at least one application criterion involves a comparison of an expected motion direction to an actual motion direction. In particular, an expected motion direction may be ascertained with the aid of the mathematical model. If this expected motion direction matches the actual motion direction, this indicates that the relation between the direction of the sensor orientation and the motion direction is to be held essentially constant.

It may be provided that multiple of the described application criteria are checked. For example, it may be provided to provide two of the application criteria, such as the recognized motion at the minimum speed and the maintenance of the sensor position, for the comparison of the expected motion direction to the actual motion direction, or to provide all three application criteria.

In one specific embodiment of the method of the present invention, a moving average of multiple measured data that are ascertained in temporal succession is used to assess whether the at least one application criterion is met. In particular periodic motions and/or motion patterns, for example caused by swinging arms or a pedaling rate when riding a bicycle, may thus be disregarded.

Exemplary embodiments of the present invention are explained with reference to the figures.

### BRIEF DESCRIPTION OF THE DRAWINGS

FIG. 1 shows a flowchart of the method according to an example embodiment of the present invention.

FIG. 2 shows an actual motion of a sensor.

FIG. 3 shows a theoretical speed diagram of the sensor.

FIG. 4 shows an actual speed diagram of the sensor.

FIG. 5 shows a motion of the sensor that is derived from the actual speed diagram.

FIG. 6 shows a flowchart of an activation process, according to an example embodiment of the present invention.

FIG. 7 shows a check of a sensor position;.

FIG. 8 shows a flowchart in a probabilistic filter, according to an example embodiment of the present invention.

FIG. 9 shows a sensor system and a processing unit, according to an example embodiment of the present invention.

### DETAILED DESCRIPTION OF EXAMPLE EMBODIMENTS

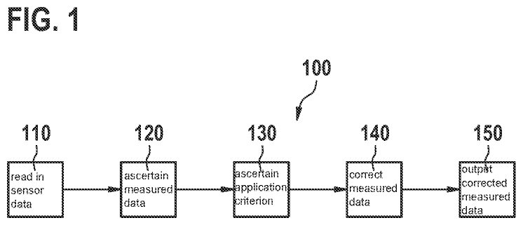

FIG. 1 shows a flowchart 100 of a method for evaluating sensor data. Raw sensor data and/or processed sensor data from a rotation rate sensor and an acceleration sensor are read in in a first method step 110. The rotation rate sensor may include a gyroscope. Measured data from the raw sensor data and/or the processed sensor data are ascertained in a second method step 120. An application criterion is ascertained in a third method step 130. The measured data are corrected in a fourth method step 140, based on a mathematical model. An angle between a direction of a sensor orientation and a motion direction is maximally changed by a predefined value per time unit when the application criterion is met. The corrected measured data are output in a fifth method step 150.

The measured data may involve in particular the motion direction and the direction of the sensor orientation. The motion direction may correspond to a direction of a velocity vector. With the aid of the application criterion it may be decided whether a certain relation between the motion direction and the direction of the sensor orientation may be held essentially constant. The underlying concept is that there may be motion situations in which the direction of the sensor orientation, i.e., the position of a sensor in space, is not changed relative to the motion direction when the sensor moves. This may be the case in particular when the sensor is carried, for example in a mobile phone or in some other handheld device. In addition, this may also apply when the sensor is situated in a vehicle. This may be utilized in particular for coupling navigation and/or inertial navigation. Due to the necessary integration of the measured data for these types of navigation, even small deviations may result in large errors. These errors may be reduced by predefining the relation between the motion direction and the direction of the sensor orientation. In addition, it may be provided that no further sensors are used besides the acceleration sensor and the rotation rate sensor.

The raw sensor data and/or the processed sensor data may either be output as an analog signal, for example in the form of a voltage, or may have already been converted into a digital signal in the sensors with the aid of electronics and A/D converters. The processed sensor data may be designed in such a way that a first variable is ascertained with the aid of the sensor, and a second variable is computed from the first variable. For example, raw sensor data of the acceleration sensor (acceleration data) may be processed to form speed data by integrating the acceleration data and thus ascertaining speeds. The processing of the raw sensor data may take place within the sensor. In addition, the processing of the raw sensor data may also take place in a processing unit that carries out the method. In particular for processed sensor data, small measuring errors or deviations in the raw sensor data due to the processing, in particular due to the integration, may result in large deviations in the processed sensor data. The method according to the present invention allows these deviations to be greatly reduced, since the speed data, which rapidly deviate due to the integration, may be checked, at least with regard to a motion direction, and corrected if necessary. This results from the implementation with the aid of the mathematical model.

The method according to the present invention may be implemented in such a way that in the mathematical model in the standard state, the angle between the direction of the sensor orientation and the motion direction is maximally changed by the predefined value per time unit, and the angle between the direction of the sensor orientation and the motion direction may also be changed by a larger amount than the predefined value only when the application criterion suggests that this relation is not to be used. However, it may also alternatively be provided that the presence of the application criterion is checked, and the mathematical model is appropriately changed only if the application criterion is present, so that the angle between the direction of the sensor orientation and the motion direction may be maximally changed by the predefined amount.

In one specific embodiment of the method, the predefined value per time unit is ten degrees per hour. Below this value, it may be assumed that a change in the relation between the motion direction and the direction of the sensor orientation is due to, for example, fatigue during a motion, for example during walking, and does not take place because of a general change in the sensor positioning. However, this also allows slow, gradual changes in position to be included.

In one specific embodiment of the method, the angle between the direction of the sensor orientation and the motion direction is held constant. This allows a simple mathematical implementation of the mathematical model.

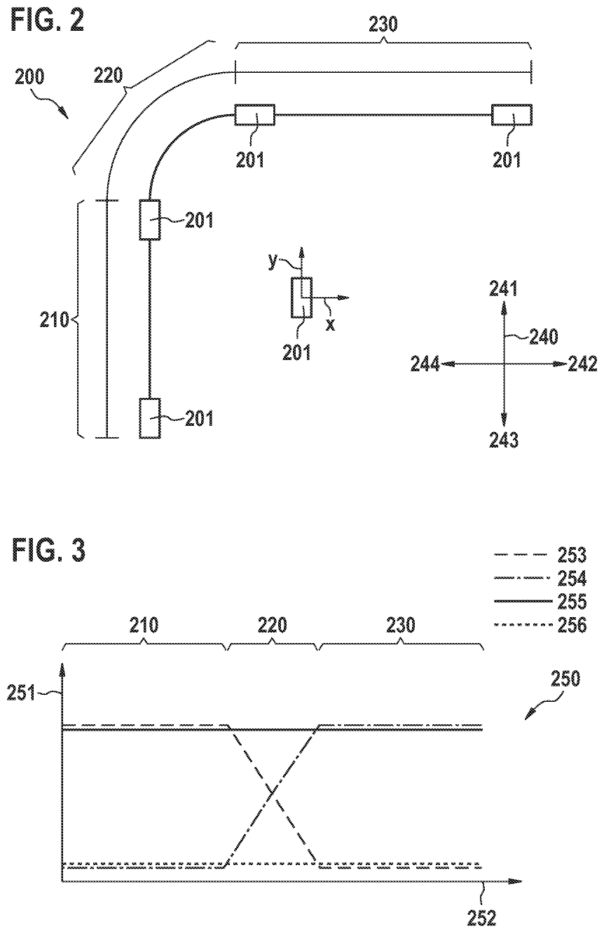

FIG. 2 shows a motion 200 of a mobile device 201, which may be designed as a mobile phone, for example. Mobile device 201 may in particular contain an acceleration sensor and a rotation rate sensor, and may also be optionally configured to carry out the method according to the present invention. Motion 200 is subdivided into a first motion phase 210, a second motion phase 220, and a third motion phase 230. In addition, a coordinate system for mobile device 201 is shown, including an x-axis and a y-axis, each situated in the plane of the drawing in FIG. 2. In addition, a z-axis may be perpendicular to the plane of the drawing in FIG. 2. Furthermore, a wind rose 240 is shown, with north 241, east 242, south 243, and west 244. Mobile device 201 moves toward north 241 in first motion phase 210, this corresponding to the y-axis in the reference system of mobile device 201. A 90-degree curve to the right is passed through in second motion phase 220. Mobile device 201 thus changes its motion direction from north 241 to east 242, this still corresponding to the y-axis in the reference system of mobile device 201. Mobile device 201 moves toward east 242 in third motion phase 230, this still corresponding to the y-axis in the reference system of mobile device 201. The motion direction of mobile device 201 has thus changed relative to the surroundings, but not relative to the internal reference system of mobile device 201.

FIG. 3 shows a diagram 250 in which speed 251 is plotted with respect to time 252. In addition, motion phases 210, 220, 230 from FIG. 2 are clearly indicated. A speed 253 in the northern direction, a speed 254 in the eastern direction, a speed 255 in the y-direction, and a speed 256 in the x-direction are shown in diagram 250. These correspond to the speeds that are expected, based on motion 200 in FIG. 2. The illustrations in FIGS. 2 and 3 represent a theoretical ideal case in which no measuring errors occur.

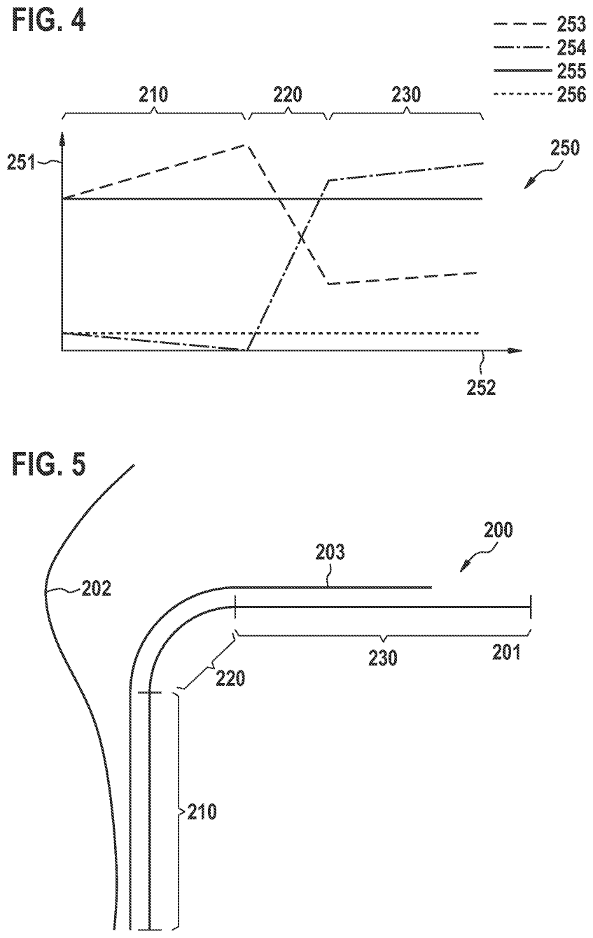

FIG. 4 shows diagram 250 from FIG. 3 for actual measured values, in which measuring errors are summed by integration. This is apparent in particular from changed speed 253 in the northern direction, compared to FIG. 3, and from changed speed 254 in the eastern direction, compared to FIG. 3. However, speed 255 in the y-direction and speed 256 in the x-direction are identical to FIG. 3, since they have not changed in relation to mobile device 201.

FIG. 5 shows motion 200 from FIG. 2, and in addition shows a motion path 202 that is ascertained based on speed 253 in the northern direction and speed 254 in the eastern direction. This motion path clearly deviates from motion 200. If an angle between a direction of a sensor orientation and a motion direction is maximally changed by a predefined value per time unit in fourth method step 140 during the correction of the measured data based on the mathematical model, this results in a further motion path 203 that is much closer to actual motion 200. This may take place in particular when the application criterion is met.

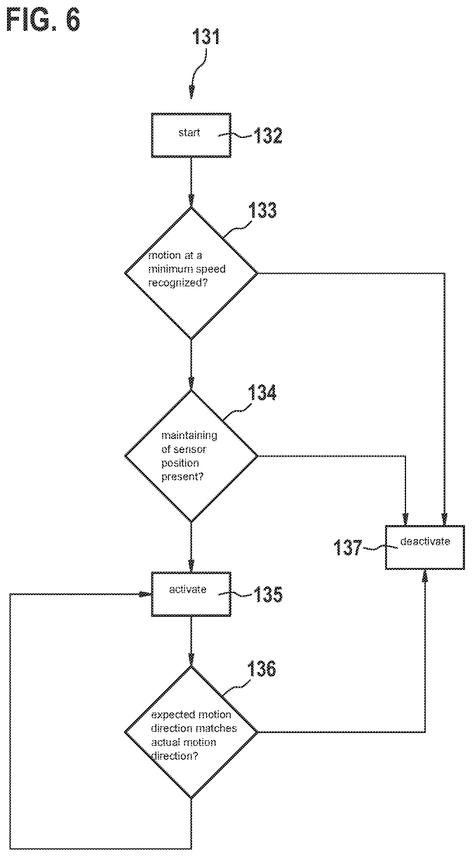

FIG. 6 shows a flowchart 131 of an activation process that may be carried out within third method step 130, for example. The application criteria described below in this regard may be provided all together or in an arbitrary subcombination. In particular, individual application criteria described below may be omitted.

The activation process is started in a starting step 132. It is checked in a first checking step 133 whether a motion at a minimum speed is recognized. The at least one application criterion may then involve the recognized motion at the minimum speed. If the sensor does not move or moves at a very low speed below the minimum speed, a motion direction cannot be reliably determined. This may be possible beginning above approximately 0.25 meter per second, so that this value may correspond to the minimum speed. Alternatively, 0.5 meter per second may be provided as a minimum speed. If the first checking step shows that a motion at the minimum speed is present, it is checked in a second checking step 134 whether a maintaining of a sensor position is present. Motions of the sensor relative to a user may thus be disregarded. For example, during walking the sensor could be initially held in the hand and subsequently held against the ear, resulting in a change in the sensor position.

While the sensor position is changing, the relation between the direction of the sensor orientation and the motion direction is not to be held essentially constant, since this relation is not constant due to the change in the sensor position. If second checking step 134 shows that the sensor position is maintained, an activation 135 takes place, and as a result of activation 135 an angle between a direction of a sensor orientation and a motion direction is maximally changed by a predefined value per time unit. It is subsequently checked in a third checking step 136 whether an expected motion direction matches an actual motion direction. In particular, an expected motion direction may be ascertained with the aid of the mathematical model. If this expected motion direction matches the actual motion direction, this indicates that the relation between the direction of the sensor orientation and the motion direction is to be held essentially constant. The activation process is then continued with activation 135. Alternatively, the activation process may also be started anew with starting step 132.

During the course of the activation process, if it turns out that for one of the three checking steps 133, 134, 136 the corresponding requirements are not met, i.e., that in first checking step 133 no motion at the minimum speed is recognized, in second checking step 134 a change in the sensor position is present, or in third checking step 136 an expected motion direction differs from an actual motion direction, a deactivation 137 may take place, the angle between a direction of sensor orientation and a motion direction then being freed up and being changeable by the mathematical model.

It is also possible to carry out only first checking step 133, only second checking step 134, or only third checking step 136 in the activation process. Furthermore, it is likewise possible to carry out only first checking step 133 and second checking step 134, only first checking step 133 and third checking step 136, and only second checking step 134 and third checking step 136, and to omit respective other checking step(s) 133, 134, 136.

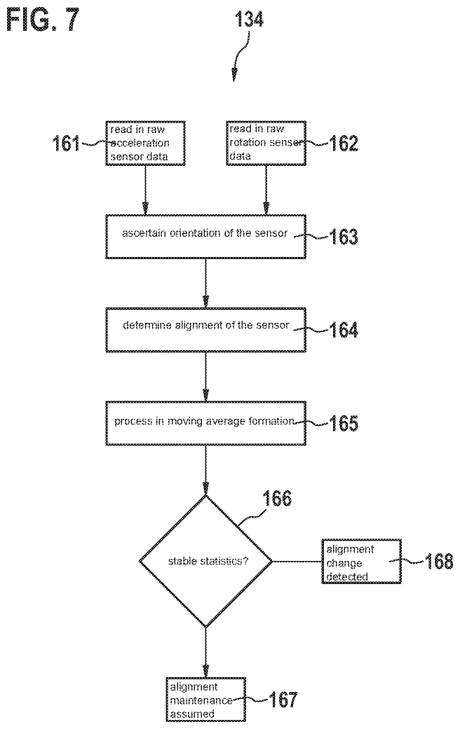

FIG. 7 shows a flowchart of second checking step 134, i.e., a check of a change in a sensor alignment. Raw acceleration sensor data are read in in an acceleration sensor reading-in step 161. Raw rotation sensor data, for example raw gyroscope data, are read in in a rotation sensor reading-in step 162. An orientation of the sensor is ascertained from the raw acceleration sensor data and the raw rotation sensor data in an orientation determination step 163. Based on same, an alignment of the sensor is determined in an alignment determination step 164. These are then processed in a moving average formation 165 and supplied to a position checking step 166. Moving average formation 165 may encompass a time window of several seconds. A low-pass filter may also be provided instead of moving average formation 165. If it turns out in position checking step 166 that the statistics of the orientation or the alignment are stable, alignment maintenance 167 may be assumed. This corresponds to the case that in second checking step 134, a maintaining of the sensor position is present and the angle between the direction of the sensor orientation and the motion direction may be held essentially constant. If it turns out in position checking step 166 that the statistics of the orientation or the alignment are not stable, an alignment change detection 168 may be assumed. This corresponds to the case that in second checking step 134, a change in the sensor position is present and the angle between the direction of the sensor orientation and the motion direction is changeable.

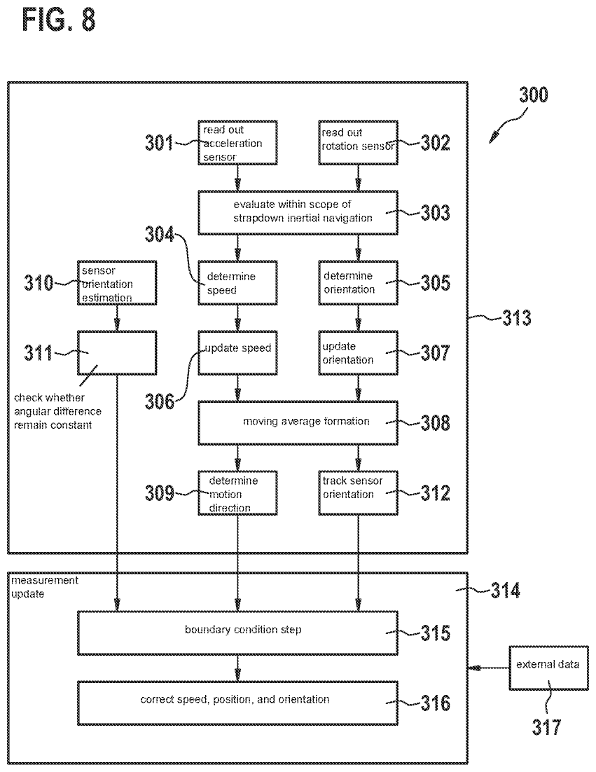

FIG. 8 shows a flowchart 300 for a probabilistic filter. An acceleration sensor read-out step 301 and a rotation sensor read-out step 302 are initially carried out. Data of the acceleration sensor read out in acceleration sensor read-out step 301 and of the rotation sensor (a gyroscope, for example) read out in rotation sensor read-out step 302 are evaluated in an evaluation step 303 within the scope of strapdown inertial navigation, and a speed (three-dimensional, for example) is determined in a speed determination step 304 and an orientation is determined in an orientation determination step 305. The speed is updated in a first update step 306, and the orientation is updated in a second update step 307. A moving average formation 308 subsequently takes place for both variables. In addition, a motion direction relative to the surroundings is determined in a motion direction determination step 309. An initial angular difference between the motion direction and the direction of the sensor orientation is estimated in a sensor orientation estimation 310. This corresponds to the alignment of the sensor in the y-axis, based on the explanations for FIGS. 2 through 5. In addition, it is checked in a checking step 311 whether the angular difference remains constant. Furthermore, the direction of the sensor orientation is tracked in a sensor orientation tracking step 312, based on the acceleration and also an angular velocity, or based solely on the angular velocity. All of these steps take place within time update 313 of the probabilistic filter. It may be provided that a prediction of the measured variables takes place within time update 313.

A measurement update 314 subsequently takes place in which the boundary condition step 315 is initially carried out, in this step a relationship being considered that may be described by the formula

Dₘₒₜᵢₒₙ=D_{sensor_orientation}·Dₛₑₙₛₒᵣ

where Dₘₒₜᵢₒₙ corresponds to the motion direction ascertained in motion direction determination step 309, for example based on wind rose 240, Dₛₑₙₛₒᵣ corresponds to the orientation of the sensor estimated in the sensor orientation estimation, and D_{sensor_orientation} corresponds to the direction of the sensor orientation as a theoretical description of the angle between Dₘₒₜᵢₒₙ and Dₛₑₙₛₒᵣ. For the theoretical description in D_{sensor_orientation} it may be provided, for example, that a certain direction of wind rose 240 is associated with a certain axis of the sensor (for example, the y-axis in FIG. 2). In this particular example, the angle may theoretically be 0 degrees, for example, for first motion phase 210. If at the start of the motion the y-axis of mobile device 201 pointed toward east 242 and mobile device 201 still moved toward north 241, the angle would be 90 degrees. There is not a direct relationship in all cases between the direction of the sensor orientation and the motion direction as a measured value. In these cases, the angle between Dₘₒₜᵢₒₙ and Dₛₑₙₛₒᵣ must then be theoretically determined. In these cases, the angle between Dₘₒₜᵢₒₙ and Dₛₑₙₛₒᵣ may be set to 0 degrees at the start of the measurement, and based on this value, changes may be detected with the aid of the measured values of the acceleration sensor and of the rotation rate sensor, or also with the rotation rate sensor alone. The formula may be rearranged to give:

Dₛₑₙₛₒᵣ=Dₘₒₜᵢₒₙ−D_{sensor_orientation}

As may be explained in conjunction with FIGS. 2 through 5, it may be assumed from Dₛₑₙₛₒᵣ that this term does not change. Thus, Dₘₒₜᵢₒₙ−D_{sensor_orientation} must also remain constant.

In addition, a magnetometer, for example, may be provided to directly determine D_{sensor_orientation}.

Speed, position, and orientation may be corrected if necessary in a correction step 316. External data 317 may also optionally be used for this purpose.

The flowchart shown in FIG. 8 may be used in particular when the mathematical model includes a probabilistic filter. The probabilistic filter may be designed as an H-infinity filter, as a sequential Monte Carlo (SMC) filter, or as a Kalman filter. The Kalman filter may be designed, for example, as a nonlinear Kalman filter, i.e., among other things, as an extended Kalman filter or as cubature Kalman filter, in particular as a square root cubature Kalman filter.

In particular when the mathematical model includes a Kalman filter, the angle between the direction of the sensor orientation and the motion direction may form a state of the Kalman filter. Depending on whether or not the application criterion is present, this state may be occupied with a great or a small uncertainty. This state may be predicted in time update 313, and the prediction may be checked in measurement update 314.

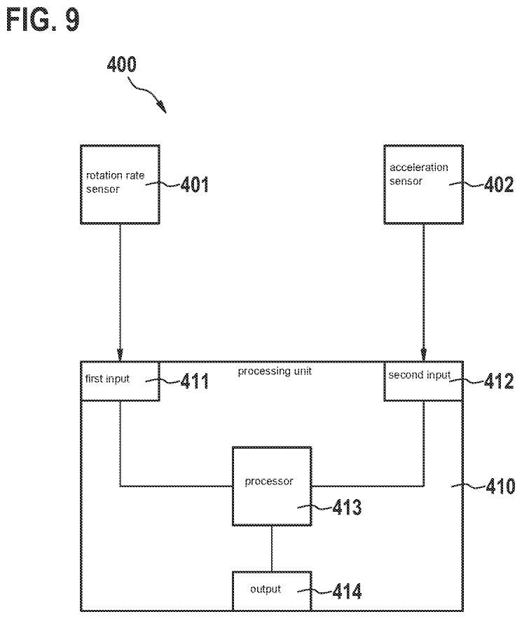

FIG. 9 shows a sensor system 400 that includes a rotation rate sensor 401 and an acceleration sensor 402, it being possible for rotation rate sensor 401 to be designed as a gyroscope, for example. Sensor system 400 also includes a processing unit 410. Processing unit 410 includes a first input 411 that is connected to rotation rate sensor 401, and a second input 412 that is connected to acceleration sensor 402. Alternatively and in contrast to the illustration, a shared input for rotation rate sensor 401 and acceleration sensor 402 may be provided. Processing unit 410 also includes a processor 413 and an output 414. Processing unit 410 is configured to receive raw sensor data and/or processed sensor data of rotation rate sensor 401 and of acceleration sensor 402 via inputs 411, 412, subsequently carry out the method according to the present invention with the aid of processor 413, in particular as explained in conjunction with FIG. 1, and then output the corrected measured data via output 414. Rotation rate sensor 401 and acceleration sensor 402 are configured to convert a physical measured variable into raw sensor data and/or processed sensor data and output same to inputs 411, 412 of processing unit 410.

Although the present invention has been described in detail using the preferred exemplary embodiments, the present invention is not limited to the examples described, and other variations may be derived therefrom by those skilled in the art without departing from the scope of protection of the present invention.

What is claimed is:

1. A method for evaluating sensor data, comprising the following steps:
reading in raw sensor data and/or processed sensor data from an acceleration sensor and a rotation rate sensor;
ascertaining measured data from the raw sensor data and/or the processed sensor data;
ascertaining at least one application criterion;
correcting the measured data based on a mathematical model, in the correction, an angle between a direction of a sensor orientation and a motion direction being maximally changed by a predefined value per time unit when the application criterion is met;
outputting the corrected measured data.

2. The method as recited in claim 1, wherein the predefined value per time unit is ten degrees per hour.

3. The method as recited in claim 1, wherein the angle between the direction of the sensor orientation and the motion direction is held constant.

4. The method as recited in claim 1, wherein the mathematical model includes a probabilistic filter including a Kalman filter.

5. The method as recited in claim 1, wherein the at least one application criterion includes a recognized motion at a minimum speed.

6. The method as recited in claim 1, wherein the at least one application criterion includes a sensor position being maintained.

7. The method as recited in claim 1, wherein the at least one application criterion includes a comparison of an expected motion direction to an actual motion direction.

8. The method as recited in claim 1, wherein a moving average of multiple measured data that are ascertained in temporal succession is used to assess whether the at least one application criterion is met.

9. A processing unit, comprising:
an input;
an output; and
a processor;
wherein the processing unit is configured to receive raw sensor data and/or processed sensor data via the input, the processing unit being configured, via the processor, to:
ascertain measured data from the raw sensor data and/or the processed sensor data,
ascertain at least one application criterion,
correct the measured data based on a mathematical model, in the correction, an angle between a direction of a sensor orientation and a motion direction being maximally changed by a predefined value per time unit when the application criterion is met, and
the processing unit being configured to output the corrected measured data via the output.

10. A sensor system, comprising:
a processing unit;
a rotation rate sensor; and
an acceleration sensor, the rotation rate sensor and the acceleration sensor each being configured to convert a physical measured variable into raw sensor data and/or processed sensor data and output them to an input of the processing unit;
wherein the processing unit includes:
the input,
an output; and
a processor;
wherein the processing unit is configured to receive the raw sensor data and/or processed sensor data via the input, the processing unit being configured, via the processor, to:
ascertain measured data from the raw sensor data and/or the processed sensor data,
ascertain at least one application criterion,
correct the measured data based on a mathematical model, in the correction, an angle between a direction of a sensor orientation and a motion direction being maximally changed by a predefined value per time unit when the application criterion is met, and
the processing unit being configured to output the corrected measured data via the output.
